(19) United States
(12) Patent Application Publication
(10) Pub. No.: US 2019/0086251 A1
(43) Pub. Date: Mar. 21, 2019

(54) METHOD OF DETERMINING A FILLING LEVEL

(71) Applicant: Marco Systemanalyse und Entwicklung GmbH, Dachau (DE)

(72) Inventor: Martin Reuter, Dachau (DE)

(21) Appl. No.: 16/130,275

(22) Filed: Sep. 13, 2018

(30) Foreign Application Priority Data
Sep. 15, 2017 (DE) 102017121426.7

(51) Int. Cl. G01F 23/18; G01L 13/06; G01L 19/00; G01F 23/00

(52) U.S. Cl. CPC G01F 23/18; G01L 13/06; G01F 23/0076; G01L 19/0084; G01L 19/0007

(57) ABSTRACT

In a method of determining a filling level in a cartridge, pressure is applied to the medium present in the cartridge and a pressure drop in the cartridge is measured to draw a conclusion on the air volume present in the cartridge.

The present invention relates to a method of determining a filling level of a cartridge that is present in a metering system and that is filled with a liquid medium above which there is an air volume.

Metering systems using cartridges are used in a large number of production systems, i.e. the liquid (that is not gaseous) medium to be metered is present in a prefilled state in cartridges having typical volumes of 30 cc to 300 cc. When the individual cartridges are used up, they have to be replaced by the operator. It is therefore useful and important for the use of metering systems in automated production systems to monitor the filling level of the cartridges so that the operator can provide and change a new, full cartridge in time. Already known systems for filling level measurement work e.g. with magnetic field sensors that can determine the position of a magnet installed in a plunger in the cartridge and can thus monitor the filling level. Ultrasound can alternatively also be used to recognize a minimal filling level.

These methods cannot be used with a large number of liquid or pasty media. An example for this is PU hot melt in 30 cc, 100 cc, or 300 cc cartridges. The medium very frequently shows a skin at the surface with these so that no plunger can be used. Measurement with ultrasound also proves to be less reliable with larger (100 cc and 300 cc) cartridges that are used in PU hot melt of aluminum. In addition, the ultrasound measurement only delivers a switching point; it does not allow any continuous determination of the filling level.

It is the object of the present invention to provide a filling level measurement that can be used universally and that enables a detection of the filling level of cartridges with an improved accuracy using simple means.

This object is satisfied by the features of the independent claims and in particular in that the pressure of the air volume in the cartridge is released to atmosphere for a predefined time period, the lowered pressure after the reaching of the predefined time period is measured, and a conclusion is drawn on the air volume present in the cartridge from the measured pressure drop.

The method in accordance with the invention enables a very simple determination of the filling level for a large number of media, and indeed independently of the design and presence of a plunger in the cartridge.

Most metering procedures and metering applications are cyclic so that typical breaks always occur. One or also more adhesive lines are, for example, applied to a workpiece and the workpiece is subsequently changed automatically or also manually. The length of the breaks is admittedly specified from the outside, i.e. by the total process of production, and is not fixed by the metering system; however, the metering system can determine how long these breaks at least always last.

This time is then available to vary the pressure in the cartridge and thus to determine the filling level. The applied supply pressure typically amounts to between 5 and 6 bar, but is possibly not very constant. The pressure applied at the cartridge can be set very exactly and maintained with respect to atmospheric pressure with the aid of a pressure regulating valve. The pressure at the cartridge is briefly released to environmental pressure/atmosphere, in particular via the pressure regulating valve, for the determination of the filling level. The pressure drop can here in particular take place via an aperture provided in the pressure regulating valve.

An empty cartridge whose outlet opening is closed can be used for a calibration of the measurement system for a metering system having a specific compilation and having specific process and environmental parameters. A further comparison for this system can be a full cartridge since full cartridges are always filled with the same quantity of medium. Since a number of cartridges are emptied after one another with a metering system, the still present residual quantity can be determined by weighing a partly emptied cartridge and the parameters of the volume measurement can thus be checked and optimized. In addition, a control of the metering system can also determine the number of metering points administered from a cartridge whose volume has been set by a corresponding adaptation of the metering parameters for an application and is known. A consistency check between the filling level measurement by means of pressure measurement and volume calculation and volume summation is thereby possible via the number of metering points.

The use of a pressure regulation valve that is equipped with a precise pressure sensor is particularly advantageous.

In accordance with an advantageous embodiment, the pressure measurement can be carried out as a differential atmospheric pressure against atmospheric pressure. This brings about the advantage that a different environmental pressure does not exert any influence on the filling level determination.

In accordance with a further advantageous embodiment, a look-up table can be used to draw a conclusion on the air volume present in the cartridge from the measured pressure drop. Which pressure development measured for a specific time period corresponds to which air volume in the cartridge can thus be stored in the look-up table. Such a look-up table can naturally be stored in a memory of an associated control.

In accordance with a further advantageous embodiment, the release of the pressure and/or the application of pressure can take place via an aperture. This brings about the advantage that a more precise control of the applied pressure and also a more precise measurement of the dropping pressure are possible due to the procedures running more slowly.

The present invention will be explained purely by way of example in the following with reference to an advantageous embodiment.

There are shown:

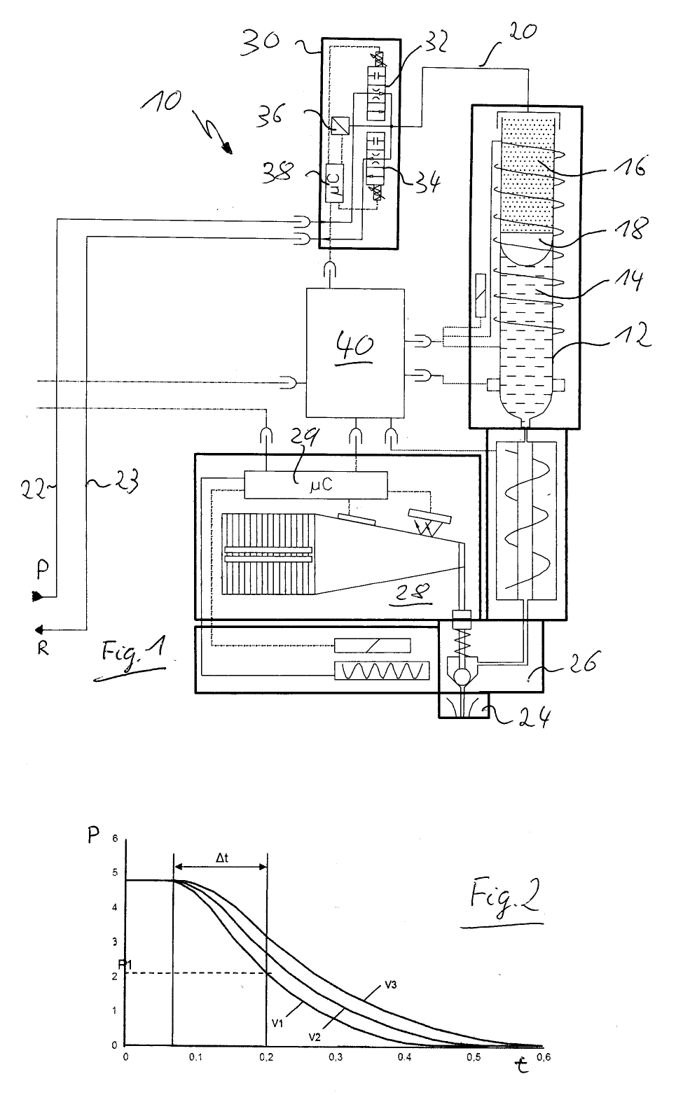

FIG. 1 a schematic view of a metering system with filling level determination; and

FIG. 2 typical pressure developments for different filling levels over time.

FIG. 1 illustrates a metering system 10 having a cartridge 12 that is partially filled with a liquid medium 14 above which there is an air volume 16. A plunger 18 can here by arranged between the liquid medium 14 and the air volume 16. It must be noted at this point that a liquid medium is understood as any non-gaseous medium in liquid, pasty, or viscous, or high-viscosity form.

The air volume 16 in the cartridge 12 is acted via a line 20 by compressed air that is supplied by a compressed air line 22. The liquid medium 14 can be expelled from the cartridge by the application of compressed air to the air volume 16 and can be dispensed through a nozzle 24, with a valve 26, not described in more detail, having a valve drive 28 being used for the dispensing of individual doses.

To apply a constant pressure to the air volume 16 in the cartridge 12, a valve unit 30 is provided between the pressure line 22 and the line 20 and comprises a first valve 32, a second valve 34, a differential pressure sensor 36, and a microcontroller 38. The microcontroller 38 is connected via a control 40 to a central control (not shown) and to a microcontroller 29 of the valve drive 28.

As FIG. 1 illustrates, the pressure line 22 is connected to the first valve 32 of the valve unit 30, with the first valve 32 (and also the second valve 34) having a total of three switching positions, namely passage, blocked, and passage via an aperture. On the application of pressure to the air volume 16, compressed air is applied via the pressure line 22 that then moves via the first valve 32 in the position shown through the aperture and further through the line 20 into the air volume 16. At the same time, the differential pressure sensor 36 measures the pressure applied in the air volume 16 of the cartridge 12. The second valve 34 is closed here. The first valve is then controlled by the microcontroller 38 such that a constant pressure of approximately 5 to 6 bar is applied. The pressure applied is measured by the differential pressure sensor 36 at every point in time.

To determine the filling level in the cartridge 12, the first valve 32 is closed and the second valve 34 is moved into the position shown in FIG. 1 such that the pressure is released from the air volume 16 and from the line 20 through the aperture of the second valve 34 into a return line 23 to atmosphere. During this process, the pressure sensor 36 measures the pressure drop as a differential pressure with respect to atmosphere and in particular the dropped pressure after reaching a predetermined time duration. A conclusion can be drawn on the air volume present in the cartridge from the measured pressure drop in that, for example, a volume value corresponding to the dropped pressure is read from a look-up table.

FIG. 2 shows a typical pressure development for different filling levels or different air volumes. A low filling level in the cartridge means a larger air volume and vice versa. In the example curves shown, the curve V1 shows the greatest pressure drop in a predefined time duration Δt, which corresponds to a smallest air volume and thus to a highest filling level. The curve V3 shows the smallest pressure drop and thus the greatest air volume and the smallest filling level in the time duration Δt. The pressure (e.g. P1 in FIG. 2) that is achieved after the defined time Δt is measured for the filling level determination. Such a measurement is possible within one to a few seconds. This time can always be found after a cartridge change or also during operation. If the measured pressure drop is known, a conclusion can be drawn on the air volume present in the cartridge either by calculation or by looking up in a look-up table. Such a look-up table can simply be obtained in that a pressure drop is measured and registered with different cartridges that have different filling levels, with the respective air volume being known for these cartridges.

The present invention also relates to a metering system of the above-described kind that has a control that is adapted to carry out the method described.

1. A method of determining the filling level of a cartridge, the cartridge being present in a metering system and the cartridge being filled with a liquid medium above which there is an air volume that is acted on by pressure, the method comprising the steps of:
measuring the pressure applied;
releasing the pressure of the air volume to atmosphere for a predetermined time duration;
measuring the dropped pressure after reaching the predetermined time duration; and
drawing a conclusion on the air volume present in the cartridge from the measured pressure drop.

2. The method in accordance with claim 1,
wherein the pressure measurement is carried out as a differential pressure measurement to atmospheric pressure.

3. The method in accordance with claim 1,
wherein a conclusion is drawn on the air volume present in the cartridge from the measured pressure drop by using a look-up table.

4. The method in accordance with claim 1,
wherein the filling level of a completely filled cartridge and of a completely emptied cartridge is determined for the calibration of the filling level.

5. The method in accordance with claim 1,
wherein the filling level of a partially emptied cartridge is determined for the calibration; wherein a residual quantity of liquid medium present in the partially emptied cartridge is determined by weighing; and wherein the actual filling level used for the calibration is calculated from the result of the weighing procedure.

6. The method in accordance with claim 1,
wherein the result of the filling level measurement is verified by counting the individual doses dispensed from a cartridge whose volume in the metering system is fixed.

7. The method in accordance with claim 1,
wherein at least one pressure regulating valve and one differential pressure sensor is used for the pressure application and for the pressure measurement.

8. The method in accordance with claim 1,
wherein the release of the pressure and/or the acting on by pressure takes/take place via an aperture.

9. The method in accordance with claim 1,
wherein metering breaks, metering interruptions and/or cartridge changes are determined in the metering system; and wherein the determination of the filling level is carried out at times corresponding to the metering breaks, metering interruptions and/or cartridge changes.

10. The method in accordance with claim 1,
wherein a minimal time for metering breaks, metering interruptions and/or cartridge changes are determined in the metering system; and wherein a check is made by the metering system whether this minimal time is sufficient for determining the filling level.

11. A metering system having at least one pressure regulation valve and one difference pressure sensor and a control that is adapted to carry out a method of determining the filling level of a cartridge, the cartridge being present in the metering system and the cartridge being filled with a liquid medium above which there is an air volume that is acted on by pressure, wherein the method comprises the steps of:
measuring the pressure applied;
releasing the pressure of the air volume to atmosphere for a predetermined time duration;
measuring the dropped pressure after reaching the predetermined time duration; and
drawing a conclusion on the air volume present in the cartridge from the measured pressure drop.
